(19) United States
(12) Patent Application Publication
(10) Pub. No.: US 2025/0286197 A1
(43) Pub. Date: Sep. 11, 2025

(54) BATTERY PACK

(71) Applicant: TOYOTA JIDOSHA KABUSHIKI KAISHA, Toyota-shi (JP)

(72) Inventors: Hazuki HITOMI, Obu-shi (JP); Shigeyuki INOUE, Toyota-shi (JP); Hiroya TAKAHASHI, Toyota-shi (JP); Kazuki SUGIE, Miyoshi-shi (JP)

(73) Assignee: TOYOTA JIDOSHA KABUSHIKI KAISHA, Toyota-shi (JP)

(21) Appl. No.: 19/051,315

(22) Filed: Feb. 12, 2025

(30) Foreign Application Priority Data
Mar. 11, 2024 (JP) 2024-037250

(51) Int. Cl. H01M 50/249; H01M 50/204; H01M 50/317

(52) U.S. Cl. CPC H01M 50/249; H01M 50/204; H01M 50/317; H01M 2220/20

(57) ABSTRACT

A battery pack according to the present disclosure is to be mounted on a vehicle, and includes, in a state in which the battery pack is mounted on a vehicle cabin lower side of the vehicle: a plurality of battery cells stacked in a front-rear direction of the vehicle; a case that accommodates the battery cells; and a shared panel disposed below the case. The battery cells each include a cell opening portion and a cell valve. The cell opening portion is provided in a bottom surface of the battery cell. The cell valve is provided in the cell opening portion. The case includes a case opening portion communicating with the cell opening portion. The case opening portion is provided in a bottom surface of the case. A smoke exhaust path is located between the case and the shared panel. The shared panel protrudes to the cell valve side.

### CROSS-REFERENCE TO RELATED APPLICATION

This application claims priority to Japanese Patent Application No. 2024-037250 filed on Mar. 11, 2024, incorporated herein by reference in its entirety.

### BACKGROUND

### 1. Technical Field

The present disclosure relates to a battery pack.

### 2. Description of Related Art

In a battery module disclosed in Japanese Unexamined Patent Application Publication No. 2023-065217, a plurality of battery cells is stacked and disposed. Further, a casing accommodates the plurality of battery cells side by side in the lateral direction. Further, a smoke exhaust cover is positioned between the plurality of battery cells and an upper plate of the casing. In the upper surface of each of the plurality of battery cells, a pressure release valve is provided. For example, when a short-circuit is caused in the battery cell, high-pressure gas or debris may be generated and released from the pressure release valve. In the following, a phenomenon in which gas or debris is released from the pressure release valve of the battery cell is sometimes simply referred to as “smoke emission”. The smoke exhaust cover can effectively guide the gas or the debris emitted from the battery cell at the time of smoke emission.

### SUMMARY

The inventors of the subject application have found the following problem.

The inventors of the subject application or the like have recalled a battery pack in which a cell valve is provided in a bottom surface of each of a plurality of battery cells. A case includes a case opening portion that faces the cell valve. A shared panel is disposed on the lower side of the case. A smoke exhaust path is formed between the shared panel and the case. In such a battery pack, at the time of smoke emission, gas or debris is emitted from the cell valve of the battery cell, passes through the case opening portion, and is guided by the shared panel and the case. That is, the debris passes through the smoke exhaust path so as to be discharged. However, the debris is sometimes accumulated on the lower side of the cell valve in the shared panel, leading to a possibility of closing the smoke exhaust path.

The present disclosure has been made in view of the above-mentioned problem, and provides a battery pack that can reduce the possibility of closing the smoke exhaust path by the debris.

A battery pack according to the present disclosure is a battery pack to be mounted on a vehicle, and includes, in a state in which the battery pack is mounted on a vehicle cabin lower side of the vehicle:
a plurality of battery cells stacked in a front-rear direction of the vehicle;
a case that accommodates the battery cells; and
a shared panel disposed below the case, in which
each of the battery cells includes a cell opening portion and a cell valve,
the cell opening portion is provided in a bottom surface of each of the battery cells,
the cell valve is provided in the cell opening portion,
the case includes a case opening portion communicating with the cell opening portion,
the case opening portion is provided in a bottom surface of the case,
a smoke exhaust path is located between the case and the shared panel, and
the shared panel protrudes to the cell valve side.

Further, in the above-mentioned battery pack, the shared panel may include a shared panel main body and a protruding portion provided below the cell valve, and the protruding portion may protrude to the cell valve side.

Further, in the above-mentioned battery pack, the protruding portion may be a tubular member having a triangular sectional shape, and the tubular member may include two outer side surfaces that intersect with each other to provide a corner that protrudes to the cell valve side

Further, in the above-mentioned battery pack, the protruding portion may be a tubular member having a trapezoidal sectional shape, and the tubular member may protrude to the cell valve side.

According to the present disclosure, it is possible to reduce the possibility of closing the smoke exhaust path by the debris.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a top view of one configuration example of a battery pack according to a first embodiment;

FIG. 2 is a sectional view of the one configuration example of the battery pack according to the first embodiment;

FIG. 3 is a sectional view of one configuration example of a battery module according to the first embodiment;

FIG. 4 is an enlarged sectional view of the one configuration example of the battery module according to the first embodiment;

FIG. 5 is an enlarged sectional view of one modification example of the battery module according to the first embodiment; and

FIG. 6 is an enlarged sectional view of another one modification example of the battery module according to the first embodiment.

### DETAILED DESCRIPTION OF EMBODIMENTS

Hereinafter, specific embodiments to which the present disclosure is applied are described in detail with reference to the drawings. However, the present disclosure is not limited to the following embodiments. Further, for the sake of clear description, the following description and drawings are simplified as appropriate.

### First Embodiment

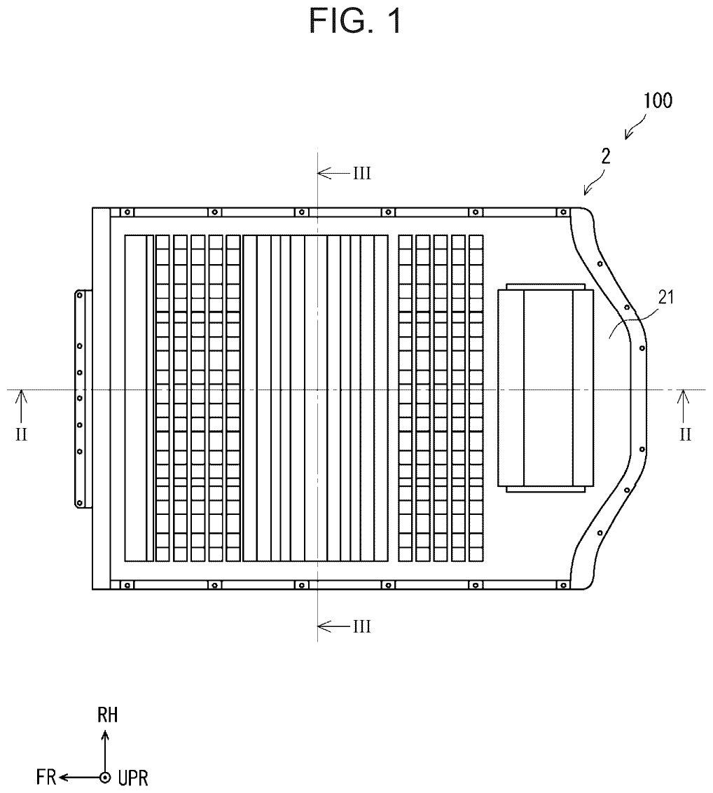

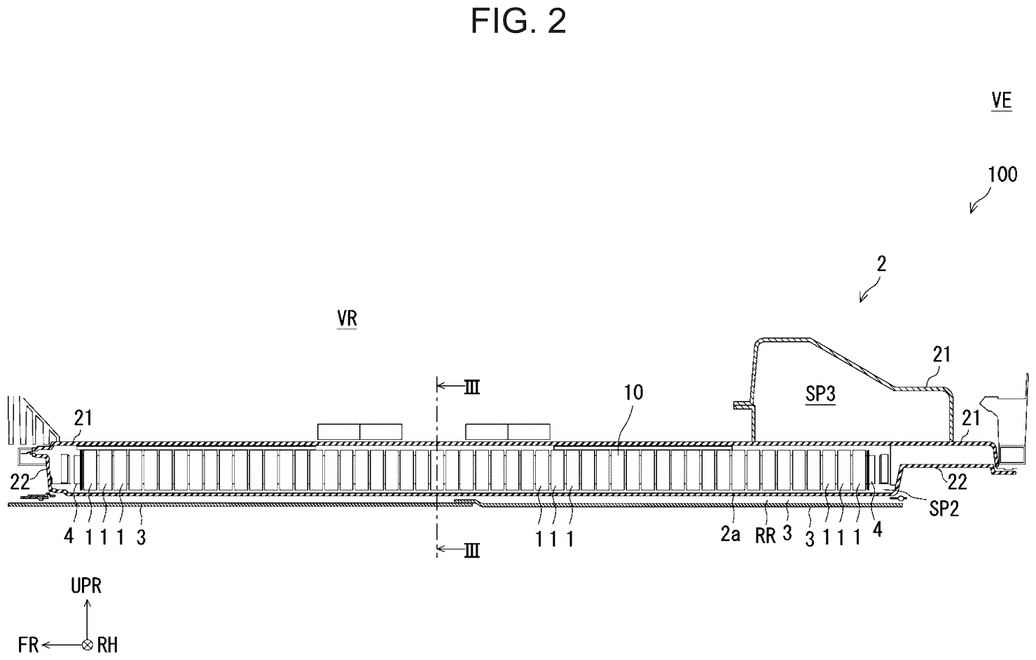

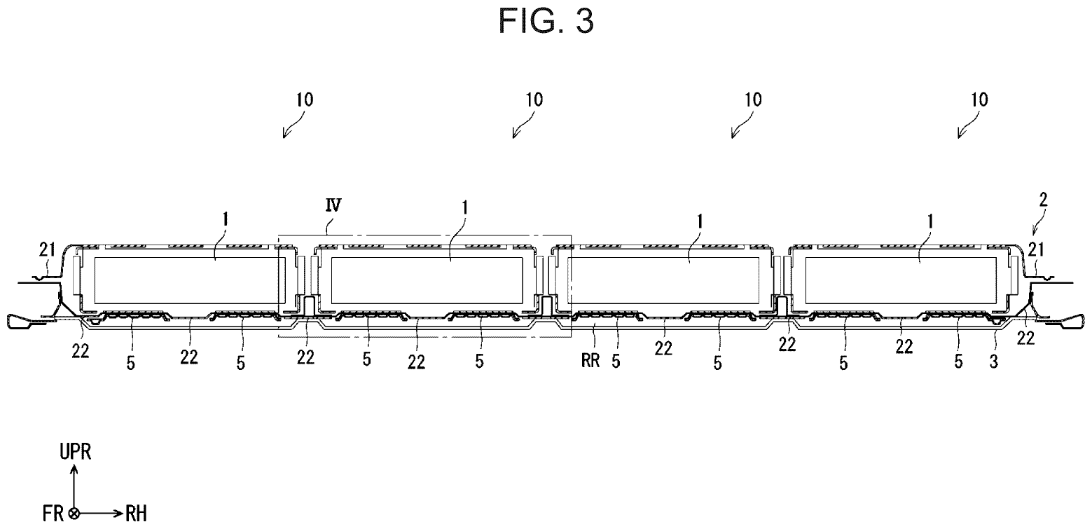

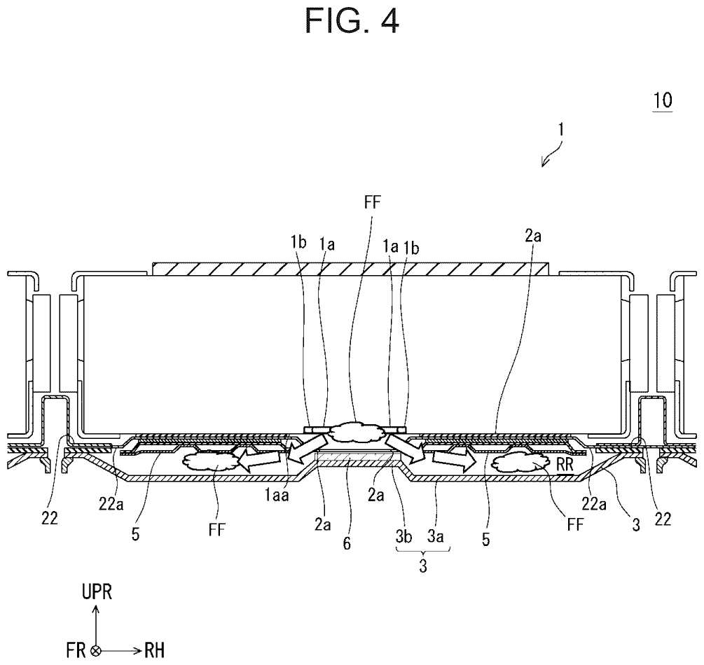

A first embodiment is described with reference to FIG. 1 to FIG. 4. FIG. 1 is a top view of one configuration example of a battery pack according to the first embodiment. FIG. 2 is a sectional view of the one configuration example of the battery pack illustrated in FIG. 1. FIG. 3 is a sectional view of one configuration example of a battery module according to the first embodiment. FIG. 4 is an enlarged sectional view of the one configuration example of the battery module illustrated in FIG. 3.

It is to be noted that, as a matter of course, the right-handed XYZ coordinates shown in FIG. 1 and other drawings are illustrated for convenience of explanation regarding a positional relation among components. Usually, a plus direction of a UPR axis represents a vertically upward direction in a vehicle VE, a plus direction of a FR axis represents a forward direction in the vehicle VE, and a plus direction of a RH axis represents a rightward direction in the vehicle VE. Further, a plane including the FR axis and the RH axis represents a horizontal plane, and these are the same throughout the drawings.

As illustrated in FIG. 1 and FIG. 2, a battery pack 100 includes battery modules 10, a case 2, and a shared panel 3. The battery pack 100 is to be mounted on the vehicle VE. The battery pack 100 is disposed on the lower side of a vehicle cabin VR of the vehicle VE.

The case 2 accommodates the battery modules 10. The battery modules 10 each extend in the FR axis direction. The case 2 includes a lower case 22 and an upper case 21. The shared panel 3 is disposed below the case 2. The shared panel 3 can receive input from a road while the vehicle VE travels. The shared panel 3 is disposed with a predetermined interval from the case 2. The shared panel 3 preferably has a size that can cover the case 2. The case 2 and the shared panel 3 are preferably configured with use of a metal material. Examples of the metal material include iron and steel and an aluminum alloy.

A smoke exhaust path RR is formed between the shared panel 3 and the case 2. At the time of smoke emission, gas emitted from the battery module 10 preferably passes through the smoke exhaust path RR to be discharged to the outside of the vehicle VE.

A cell space SP2 is formed between the lower case 22 and the upper case 21. The battery modules 10 are accommodated in the cell space SP2.

An equipment space SP3 is preferably formed on the inner side of the upper case 21. In the equipment space SP3, equipment configuring the vehicle VE is preferably disposed.

The battery modules 10 each include a plurality of battery cells 1 and two end plates 4. The plurality of battery cells 1 is preferably stacked in the FR axis direction through intermediation of a heat insulating material or the like. The two end plates 4 preferably sandwich the plurality of battery cells 1 through intermediation of a heat insulating material or the like. As illustrated in FIG. 3, the battery modules 10 are disposed in parallel in the case 2. In the example illustrated in FIG. 3, four battery modules 10 are disposed in parallel in the RH axis direction in the case 2.

As illustrated in FIG. 3 and FIG. 4, a cooler 5 is preferably provided on a bottom surface 22a of the lower case 22. The cooler 5 may be in contact with the bottom surface 22a of the lower case 22 through intermediation of a thermally conductive adhesive. The cooler 5 is preferably made of a material having good thermal conductivity. Examples of the material include aluminum, copper, and an alloy thereof.

As illustrated in FIG. 4, the battery cell 1 includes a cell opening portion 1b and a cell valve 1a. The cell opening portion 1b is provided in a bottom surface 1aa of the battery cell 1. The cell valve 1a is provided in the cell opening portion 1b. In an example of the cell valve 1a illustrated in FIG. 4, the cell valve 1a is provided near a center in the bottom surface 1aa of the battery cell 1. A positive terminal and a negative terminal are preferably provided respectively on both side surfaces of the battery cell 1. The case 2 includes a case opening portion 2a communicating with the cell opening portion 1b. The case opening portion 2a is provided in the bottom surface 22a of the lower case 22. The case opening portion 2a may be provided with a case valve. The cooler 5 is preferably provided around the case opening portion 2a.

The shared panel 3 protrudes to the cell valve 1a side. Specifically, the shared panel 3 includes a shared panel main body 3a and a protruding portion 3b. The shared panel main body 3a faces the bottom surface 22a of the lower case 22. The protruding portion 3b is provided below the cell valve 1a (in this case, a minus direction of the UPR axis). The shared panel main body 3a and the protruding portion 3b are continuous with each other. The protruding portion 3b protrudes to the cell valve 1a side (in this case, the plus direction of the UPR axis). Further, a protection member 6 may cover the protruding portion 3b to protect the protruding portion 3b. Protection of the protruding portion 3b by the protection member 6 is preferred because occurrence of erosion can be prevented. The heat resistance of the protection member 6 is preferably higher than the heat resistance of the shared panel 3. The protection member 6 is preferably made of a heat resistant material, 30 and examples of the heat resistant material include mica.

In this case, when smoke emission occurs in the battery cell 1, gas FF or high-pressure debris is generated inside of the battery cell 1, and the debris reaches the cell valve 1a. Then, the cell valve 1a is opened. The debris passes through the case opening portion 2a to reach the shared panel 3. As described above, the shared panel 3 protrudes to the cell valve 1a side. Accordingly, the shared panel 3 divides the debris to both sides in the longitudinal direction (the RH axis direction) of the battery cell 1. Thus, the debris can be dispersed on the shared panel 3.

Further, the shared panel 3 according to this embodiment includes the shared panel main body 3a and the protruding portion 3b provided below the cell valve 1a. The protruding portion 3b protrudes to the cell valve 1a side. With such a configuration, the protruding portion 3b divides the gas FF or the debris to both sides in the longitudinal direction (the RH axis direction) of the battery cell 1. Accordingly, the debris can be dispersed while the heat is prevented from being transmitted from the exhausted smoke to the shared panel 3.

### Modification Example of Shared Panel

Next, each modification example of the shared panel 3 is described.

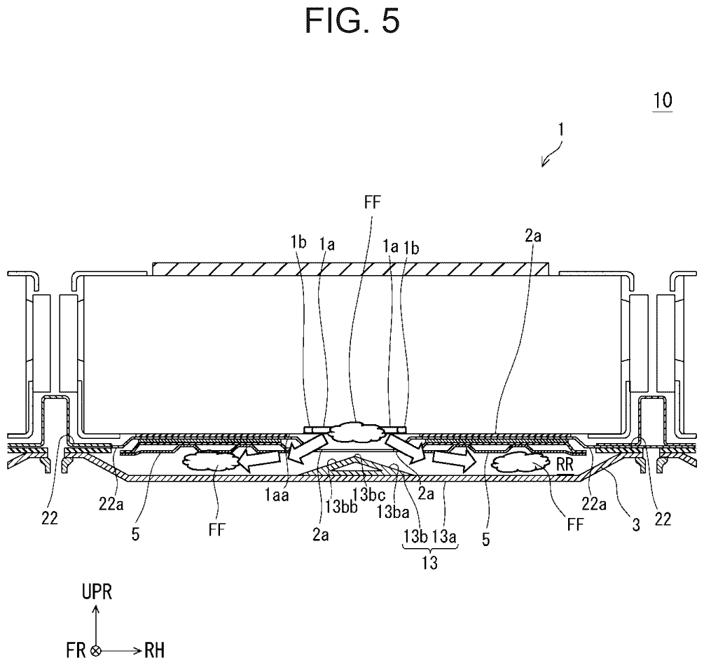

A shared panel 13 illustrated in FIG. 5 is one modification example of the shared panel 3 illustrated in FIG. 4. FIG. 5 is an enlarged sectional view of one modification example of the battery module according to the first embodiment. The shared panel 13 includes a shared panel main body 13a and a protruding portion 13b. The shared panel main body 13a faces the bottom surface 22a of the lower case 22. The protruding portion 13b is provided below the cell valve 1a (the minus direction of the UPR axis). The protruding portion 13b is disposed on the shared panel main body 13a. The protruding portion 13b is a tubular member having a triangular sectional shape. The tubular member preferably extends in the FR axis direction. The tubular member includes outer side surfaces 13ba, 13bb. The outer side surfaces 13ba, 13bb intersect with each other to form a corner 13bc. The corner 13bc protrudes to the cell valve 1a side (the plus direction in the UPR axis). With such a configuration, the corner 13bc divides the gas FF or the debris to both sides in the longitudinal direction (the RH axis direction) of the battery cell 1. Further, the protruding portion 13b is a tubular member, and hence reduces heat conduction between the gas FF or the debris and the shared panel main body 13a. Thus, the debris can be further dispersed while the heat insulating effect is enhanced.

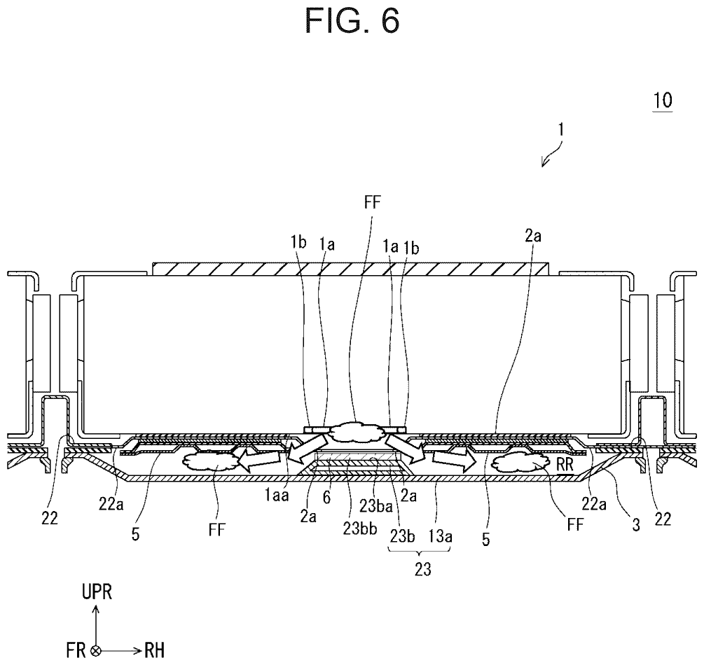

Further, a shared panel 23 illustrated in FIG. 6 is another one modification example of the shared panel 3 illustrated in FIG. 4. FIG. 6 is an enlarged sectional view of another one modification example of the battery module according to the first embodiment. The shared panel 23 includes the shared panel main body 13a and a protruding portion 23b. The protruding portion 23b is provided below the cell valve 1a (the minus direction of the UPR axis). The protruding portion 23b is disposed on the shared panel main body 13a. The protruding portion 23b is a tubular member having a trapezoidal sectional shape. The tubular member preferably extends in the FR axis direction. The trapezoidal shape has a first base 23ba positioned on the cell valve 1a side, and a second base 23bb positioned on the shared panel main body 13a side. The first base 23ba is positioned on the cell valve 1a side, and the second base 23bb is positioned on the shared panel main body 13a side. The first base 23ba is preferably shorter than the second base 23bb. With such a configuration, the protruding portion 23b divides the gas FF or the debris to both sides in the longitudinal direction (the RH axis direction) of the battery cell 1. Further, the protruding portion 23b is a tubular member, and hence reduces heat conduction between the gas FF or the debris and the shared panel main body 13a. Thus, the debris can be further dispersed while the heat insulating effect is enhanced.

It is to be noted that the present disclosure is not limited to the above-mentioned embodiments, and can be modified as appropriate without departing from the gist. Further, the present disclosure may be embodied by combining the above-mentioned embodiments and examples thereof as appropriate.

What is claimed is:

1. A battery pack to be mounted on a vehicle, the battery pack comprising, in a state in which the battery pack is mounted on a vehicle cabin lower side of the vehicle:
a plurality of battery cells stacked in a front-rear direction of the vehicle;
a case that accommodates the battery cells; and
a shared panel disposed below the case, wherein
each of the battery cells includes a cell opening portion and a cell valve,
the cell opening portion is provided in a bottom surface of each of the battery cells,
the cell valve is provided in the cell opening portion,
the case includes a case opening portion communicating with the cell opening portion,
the case opening portion is provided in a bottom surface of the case,
a smoke exhaust path is located between the case and the shared panel, and
the shared panel protrudes to the cell valve side.

2. The battery pack according to claim 1, wherein:
the shared panel includes a shared panel main body and a protruding portion provided below the cell valve; and
the protruding portion protrudes to the cell valve side.

3. The battery pack according to claim 2, wherein:
the protruding portion is a tubular member having a triangular sectional shape; and
the tubular member includes two outer side surfaces that intersect with each other to provide a corner that protrudes to the cell valve side.

4. The battery pack according to claim 2, wherein:
the protruding portion is a tubular member having a trapezoidal sectional shape; and
the tubular member protrudes to the cell valve side.
